(19) United States
(12) Patent Application Publication
(10) Pub. No.: US 2013/0187606 A1
(43) Pub. Date: Jul. 25, 2013

(54) CHARGER FOR A CELL PHONE OR TABLET PERSONAL COMPUTER WITH FUNCTION OF WINDING A WIRE

(71) Applicant: Shao-Chieh TING, New Taipei City (TW)

(72) Inventor: Shao-Chieh TING, New Taipei City (TW)

(21) Appl. No.: 13/355,890

(22) Filed: Jan. 23, 2012

(51) Int. Cl. H02J 7/00

(52) U.S. Cl. 320/114

(57) ABSTRACT

The present invention discloses a charger for a cell phone or tablet personal computer with function of winding a wire. The charger includes a main unit, a power plug that is put in a groove of the main unit, a transmission wire that is wound in a double C-slot at a side of the main unit, and a charging connector that is fixed in a positioning dip or a containing groove of the main unit. The present invention enables a charging wire associated with the charger to be wound and contained along the side as an integral unit, thereby facilitating carrying.

### BACKGROUND OF THE INVENTION

a) Field of the Invention

The present invention relates to a charger for a cell phone or tablet personal computer with function of winding a wire.

b) Description of the Prior Art

A transmission wire associated with a charger for a cell phone or tablet personal computer is mostly without a containing device. Thus, the transmission wire is very inconvenient to be carried by a user and is even lack of order in a pocket. As a result, a further research is conducted by the present inventor to develop a charger for a cell phone or tablet personal computer with function of winding a wire.

### SUMMARY OF THE INVENTION

The primary object of the present invention is to provide a charger for a cell phone or tablet personal computer with function of winding a wire, allowing an associated charging wire to be wrapped and contained along a side as an integral unit to facilitate carrying.

To achieve the aforementioned object, the technical means of the present invention is to provide a charger for a cell phone or tablet personal computer with function of winding a wire; wherein, the charger includes a main unit, a power plug that is put in a groove of the main unit, a transmission wire that is wound in a double C-slot at a side of the main unit, and a charging connector that is fixed in a positioning dip or containing groove of the main unit.

The side of the main unit is provided with a space for winding and containing the transmission wire.

The containing method of the transmission wire is winding in overlaps or winding in spirals.

The charging connector is provided with a positioning bump and the charging connector is fixed on the main unit by fitting the positioning bump with the positioning dip of the main unit.

After using the abovementioned means, the side of the main unit of the present invention is provided with the double C-slot for wrapping the transmission wire to contain the transmission wire associated with the charger. Therefore, there will be no more trouble for the disorder when containing the transmission wire. The shape of the charger of the present invention is novelty and pretty and the integrity will not be affected by containing the transmission wire. The power plug of the charger uses a rotation design and can be hidden in the main unit when not in use, which further facilitates carrying.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional schematic view of the present invention after being assembled.

FIG. 2 shows a three-dimensional schematic view of the present invention, wherein a transmission wire is not contained.

FIG. 3 shows a three-dimensional schematic view of another embodiment of the present invention after being assembled.

FIG. 4 shows a three-dimensional exploded view of another embodiment of the present invention.

### DETAILED DESCRIPTION OF THE PREFERRED EMBODIMENTS

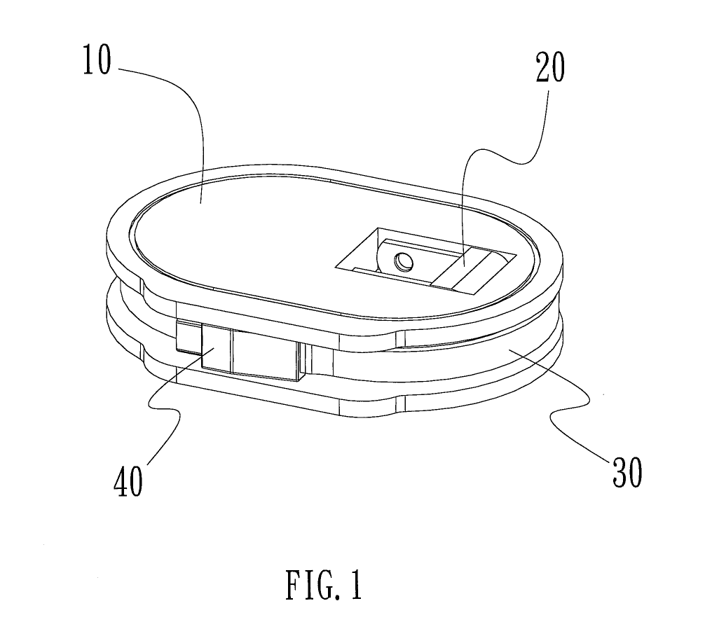

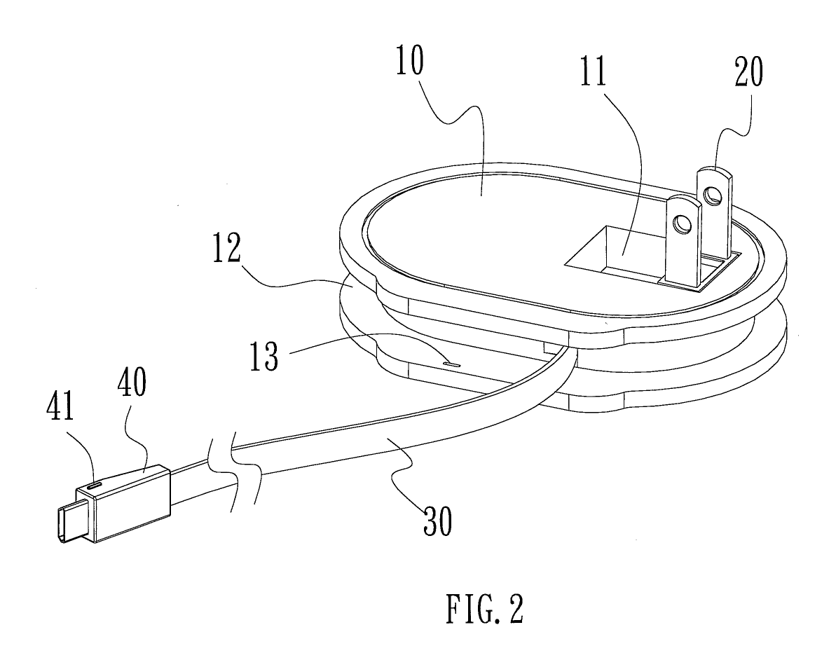

Referring to FIG. 1 and FIG. 2, it shows three-dimensional views of a charger for a cell phone with function of winding a flat transmission wire. As shown in the drawings, the charger for a cell phone of the present invention comprises a main unit 10, a power plug 20, a transmission wire 30 and a charging connector 40, wherein the main unit 10 is provided with a groove 11 for putting the power plug 20, and a side of the main unit 10 is provided with a double C-slot 12 for wrapping the transmission wire 30 in overlaps. The double C-slot 12 is in a shape of “][” and is provided with a positioning dip 13; whereas, the charging connector 40 is provided with a positioning bump 41 and is fixed on the main unit 10 by fitting the positioning bump 41 with the positioning dip 13 of the main unit 10. Therefore, the charging connector 40 will not be ejected out automatically. The side of the main unit 10 is also provided with a space for wrapping and containing the transmission wire 30.

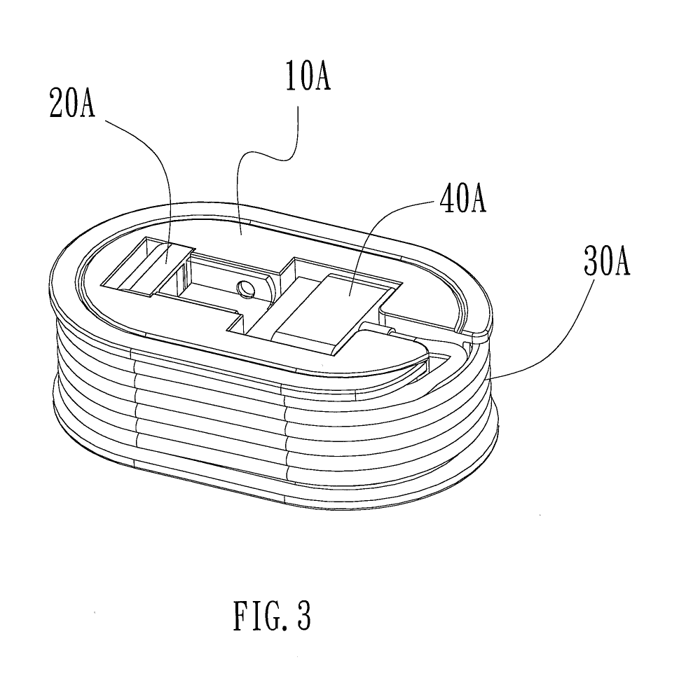

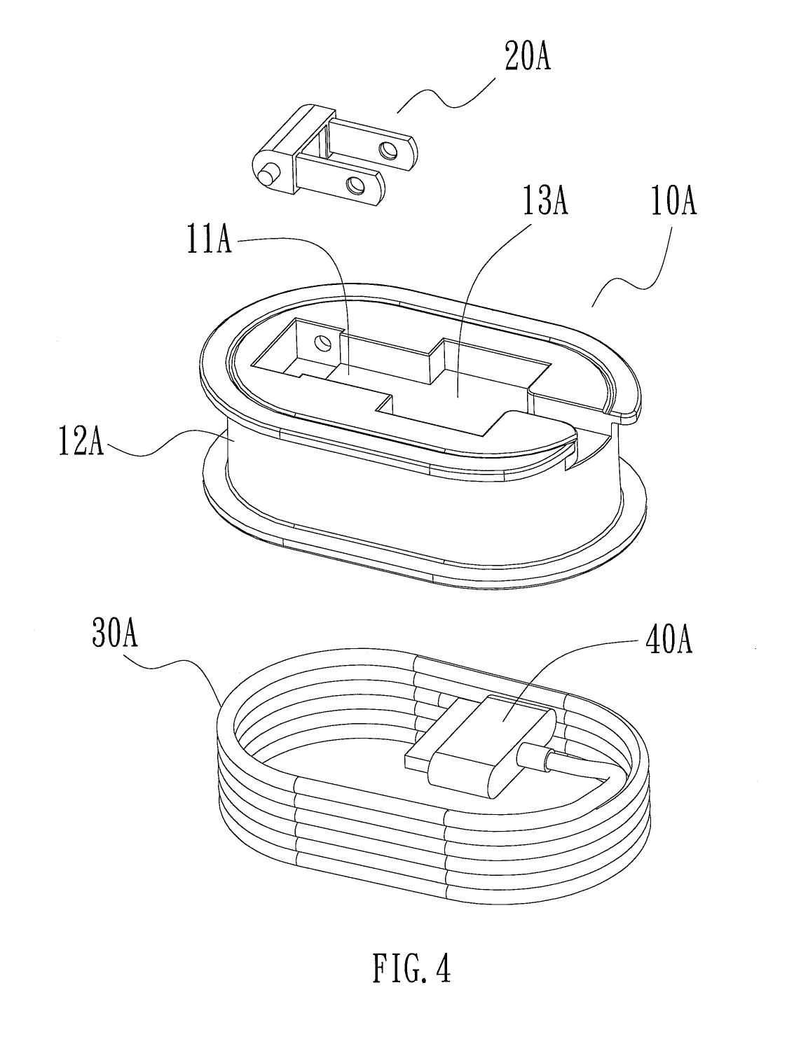

Referring to FIG. 3 and FIG. 4, it shows another embodiment of the present invention, disclosing three-dimensional views of a charger for a tablet personal computer with function of winding a round transmission wire. As shown in the drawings, the charger for a tablet personal computer of the present invention comprises a main unit 10A, a power plug 20A, a transmission wire 30A and a charging connector 40A, wherein the main unit 10A is provided with a groove 11A for putting the power plug 20A and a containing groove 13A for containing the charging connector 40A. A side of the main unit 10A is provided with a double C-slot 12A for wrapping the transmission wire 30A in spirals and the double C-slot 12A is in a shape of “][”.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. The charger for a cell phone or tablet personal computer with function of winding a wire, comprising:
a main unit;
a power plug is put in a groove of the main unit;
a transmission wire is wound in a double C-slot at a side of the main unit; and
a charging connector is fixed in a positioning dip or a containing groove of the main unit.

2. The charger for a cell phone or tablet personal computer with function of winding a wire, according to claim 1, wherein a side of the main unit is provided with a space for winding and containing the transmission wire.

3. The charger for a cell phone or tablet personal computer with function of winding a wire, according to claim 1, wherein the transmission wire is contained by winding in overlaps or winding in spirals.

4. The charger for a cell phone or tablet personal computer with function of winding a wire, according to claim 1, wherein the charging connector is provided with a positioning bump and is fixed on the main unit by fitting the positioning bump with the positioning dip of the main unit.
